(19) United States
(12) Patent Application Publication
(10) Pub. No.: US 2017/0332841 A1
(43) Pub. Date: Nov. 23, 2017

(54) Thermal Imaging Cooking System

(71) Applicant: Michael Reischmann, Eustis, FL (US)

(72) Inventor: Michael Reischmann, Eustis, FL (US)

(21) Appl. No.: 15/602,333

(22) Filed: May 23, 2017

Related U.S. Application Data
(60) Provisional application No. 62/340,159, filed on May 23, 2016.

(51) Int. Cl. A47J 37/07; G01J 5/00; A47J 36/00; F24C 7/08; G01N 25/00

(52) U.S. Cl. CPC A47J 37/0786; F24C 7/083; G01N 25/00; A47J 36/00; G01J 5/0003; G01J 2005/0081; G01J 2005/0077

(57) ABSTRACT

A cooking temperature sensor having a controller including a thermal imaging camera which identifies at least one food item in a cooking environment. A display is in communication with the controller and the controller transmits data representative of the at least one food item for display. A selection is received in connection with the data and associates a temperature with the at least one food item. The controller monitors a thermal value of the at least one food item and generates an alert indicative of when the temperature is reached for the at least one food item.

### FIELD OF THE INVENTION

The invention relates to thermal camera and imaging systems and associated software and controls configured to detect temperature of food during cooking and/or issue alerts to users when food is done.

### BACKGROUND OF THE INVENTION

Many cooking enthusiasts enjoy grilling, especially in the summer months, and there are numerous devices contemplated for measuring internal temperature of meats in order to determine when the meat has reached the desired internal temperature. The most common of these systems is a temperature probe. Some temperature probes include a gauge on the end of a rigid probe that is inserted into the meat. The probe then reads the temperature at the point where the probe is inserted. However, if the cut of meat is relatively thick, for example, a filet roast, the probe could be inserted closer to the outer surface than the middle. This could cause a temperature displayed not to be the correct temperature for cooking purposes.

The rigid probes with a gauge on the end also suffer the disadvantage that they cannot be viewed when the grill lid is closed. In order to solve this, probes have been designed with heat insulated electric sensor wires extending from the end of a rigid probe. A digital readout is then placed on the outside of the grill so that temperature can be seen with limited need to open the grill lid. Although this may work for a few pieces of meat, the need for wires can become burdensome for the cook and may become tangled.

It may be desired to cook numerous items at once on a large grill surface. These items may be of varying thickness and the grill may have “hot spots” which could lead to certain items cooking faster than others. Although it would be possible to have a probe and wire for each piece of food that runs to a digital readout, if the cook is making 10 hamburgers and 5 pieces of fish, there would be too many wires and probes to keep track of.

Typical cooking guidelines depend on the internal temperature being measured at the center of the cut of meat. Although the guidelines designate certain temperatures as final temperatures for the middle of the meat, there is often a carryover effect that causes the internal temperature of the meat to increase for a number of minutes after the meat is removed from the grill/heat source. Therefore, if the desired temperature is 145° F., it is typically recommended to remove the meat once the internal temperature is lower, for example at 135° F.

In addition, cooking and grilling is often a social event, and the cook can become distracted from cooking which can lead to food becoming over cooked, and temperature guidelines can be difficult to remember for each meat.

Therefore, it is desirable to provide a system that assists with monitoring multiple food items in a wireless and easy to use system.

### SUMMARY OF THE INVENTION

It is an object of the invention to provide a food temperature monitoring device that uses thermal imaging to detect internal temperatures of multiple items on a grilling surface or in a cooking environment.

It is yet another object of the invention to provide an interface that provides alerts as desired temperatures are reached.

It is still another object of the invention to monitor and determine cooking carryover time.

It is still another object of the invention to provide a system that allows for user selection of food items and categorization based on type in order to determine and issue alerts as desired internal temperatures are reached for different food types.

It is yet another object of the invention to provide a monitoring system for grills that can be easily attached to grill lids or other locations so that temperature of food can be monitored without opening grill lids.

These and other objects are achieved by providing a cookingtemperature sensor having a controller including a camera coupled thereto. The camera may be a thermal imaging camera and may identify at least one food item in a cooking environment. A display is in communication with the controller and the controller transmits data representative of the at least one food item for display. A selection is received in connection with the data and associates a temperature with the at least one food item. The controller monitors a thermal value of the at least one food item and generating an alert indicative of when the temperature is reached for the at least one food item.

In one aspect a grill temperature sensor is provided including a controller with a camera coupled thereto, the camera identifying thermal properties of at least one food item on a grill. A display is in communication with the controller and the controller transmits data representative the thermal properties of the at least one food item for display. A selection is received in connection with the data and associates a temperature with the at least one food item. The controller monitors a thermal value of the at least one food item and generates an alert indicative of when the temperature is reached for the at least one food item.

In certain aspects, the data is an image. In other aspects the selection is an area containing at least two food items. The selection may be indicative of food type and doneness. The doneness is based on a scale between rare and well done. In further aspects, a housing has the controller, camera and display coupled thereto such that the grill temperature sensor is a hand holdable device. In further aspects, the device includes a trigger positioned on the housing such that activation of the trigger causes a thermal image to be taken by the camera for processing by the controller. In yet other aspects, the alert is indicative of when the at least one food item is suggested to be flipped. In still other aspects, the controller is configured to communicate wirelessly with a mobile device having the display thereon.

In other aspects, a cooking temperature sensor includes a controller and a camera in communication with the controller. The camera identifies thermal properties of at least one food item in a cooking environment based at least in part on infrared energy emitted by the at least one food item as measured by the camera. The controller is configured to receive signals from the camera, the signals indicative of the thermal properties. A selection is received by the controller to associate a temperature with the at least one food item. Software executes on the controller to determines a thermal value of the at least one food item based on the thermal properties identified by the camera. The software generates an alert indicative of when the temperature is reached for the at least one food item.

In other aspects the selection is indicative of food type and doneness. In other aspects, the thermal value is determined at least based on an emissivity of the at least one food item. In further aspects the selection indicates a food type having an emissivity associated therewith. The software may identify the food item by determining a boundary associated therewith. The boundary may be determined based on identifying a first temperature associated with a grilling surface and comparing the first temperature to the thermal value wherein the boundary is defined around a perimeter of the at least one food item where the first temperature is at least 1.5 times the thermal value.

In yet other aspects, based on the selection, the temperature is determined at least in part based on a thickness of the at least one food item. In certain aspects the selection is indicative of a final temperature and the temperature is calculated based on an estimated carry-over temperature change such that the alert is generated when the temperature is lower than the final temperature.

In still other aspects a method is provided for measuring a temperature of one or more food items on a grill. The method may include one or more steps of: capturing with an imaging device an infrared energy associated with an area of the grill; identifying the one or more food items based on a drop in the infrared energy being measured in a closed loop pattern within the area; associating a temperature with at least one of the identified one or more food items; and generating an alert when the temperature is reached.

In particular aspects the drop is at least 1.5 times a measured temperature adjacent to the closed loop pattern over a distance of one inch, half an inch or a quarter inch or less.

Other objects of the invention and its particular features and advantages will become more apparent from consideration of the following drawings and accompanying detailed description.

### BRIEF DESCRIPTION OF THE DRAWINGS

FIG. 1 is a diagram of the present invention.

FIG. 2 is a perspective view of the grill of FIG. 1.

FIG. 3 is a perspective view of the grill of FIG. 1 with the thermal sensor removed.

FIG. 4 is a method diagram of the device shown in FIG. 1.

FIG. 5 is a diagram showing a handheld embodiment.

FIG. 6 is a diagram of a grill and temperature graph thereof in accordance with FIG. 1

### DETAILED DESCRIPTION OF THE INVENTION

Referring now to the drawings, wherein like reference numerals designate corresponding structure throughout the views. The following examples are presented to further illustrate and explain the present invention and should not be taken as limiting in any regard. All temperatures provided herein as examples are in Fahrenheit unless otherwise indicated, but the system may run on the Celsius or other temperature scale as would be apparent to one of skill in the art.

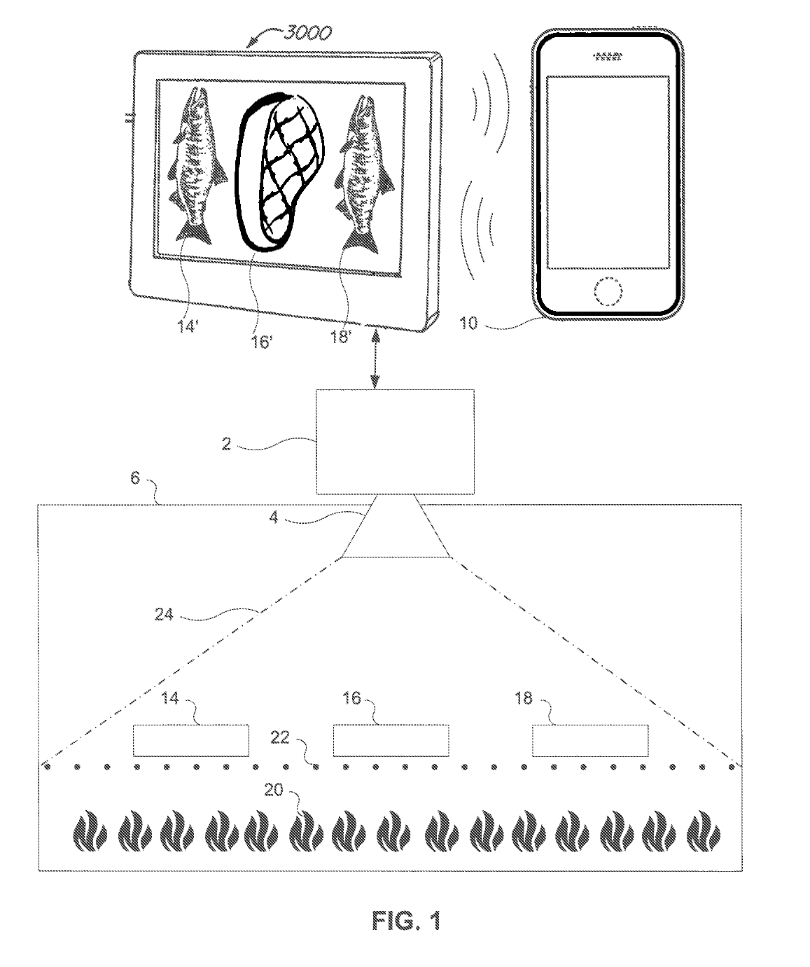

In FIG. 1 the grill enclosure 6 or cooking environment is shown with a controller 2 having a camera 4 which may be a thermal imaging camera such as an infrared camera/imager. One example of an infrared camera system is disclosed in U.S. Pat. Pub. No. 20070023661 to Wagner et. al., the content of which is incorporated by reference herein.

In one embodiment, the thermal imaging camera detects infrared energy and converts the detected energy into an electronic signal. This electronic signal is processed to produce a thermal image and to perform temperature calculations. Common cameras detect visible light in the 450-750 nanometer range. Infrared cameras detect wavelengths as long as 14,000 nm. The thermal image typically displays the hottest parts in white with intermediate temperatures in reds and yellows and the coolest parts as black, although other color configurations are contemplated.

Thermal imaging cameras detect and measure the sum of infrared energy over a range of wavelengths determined by the sensitivity of the camera's detector. Thermal imagers calculate the temperature of objects by detecting and quantifying the emitted energy over the range of the detector. Temperature is then calculated by relating the measured energy to the temperature of a blackbody radiating an equivalent amount of energy according to Planck's Blackbody Law.

$${B}_{v} ( v , T ) = \frac{2 {hv}^{3}}{{c}^{2}} \frac{1}{{e}^{\frac{hv}{{k}_{B} T}} - 1}$$

According to this equation, k_{B} the Boltzmann constant, h is the Planck constant, and c is the speed of light in the medium, whether material or vacuum.

The spectral radiance can also be measured per unit wavelength instead of per unit frequency. In this case, it is given by the following equation:

$${B}_{λ} ( λ , T ) = \frac{2 {hc}^{2}}{{λ}^{5}} \frac{1}{{e}^{\frac{hc}{λ {k}_{B} T}} - 1} .$$

The law may also be expressed in other terms, such as of the number of photons emitted at a certain wavelength, or of the energy density in a volume of radiation. Because the emissivity of an object affects how much energy an object emits, emissivity also influences a thermal imager's temperature calculation. Consider the case of two objects at the same temperature, one having high emissivity and the other low. Even though the two objects have the same temperature, the one with the low emissivity will radiate less energy. Consequently, the temperature calculated by the thermal imager will be lower than that calculated for the high emissivity object.

Many thermal imaging cameras calculate the “apparent” temperature of objects. The apparent temperature of an object is a function of both its temperature and emissivity. Given two objects with the same true temperature but different emissivity, a higher apparent temperature will be calculated for the object with higher emissivity. Given two objects with the same emissivity but different true temperature, a higher apparent temperature will be calculated for the object with higher true temperature. The apparent temperature of an object may be substantially different from its true temperature. Only when the emissivity of objects is known can thermal imagers compensate for emissivity and calculate true temperature. In the examples discussed below a standard emissivity can be used for different food types or for all food types, depending on the desired configuration.

Referring again to the figures, the grill surface 22 is shown with three food items 14/16/18 thereon. As shown on the display item 14 corresponds to image 14′ and so on. The grill enclosure 6 may have a heat source 20 that is natural gas, propane, electric, charcoal or other suitable fuel. The controller 2 may include a processor with software executing thereon for reading the images picked up by the camera 4, calculating cooking times, and carryover times and performing other operations contemplated herein. Camera 4 may be a thermal imaging camera. Camera 4 may also be configured to measure distances in order to determine thickness of food items.

The images are shown displayed on display 3000. For purposes of explanation, the images 14′, 16′ and 18′ are shown as food items, however, it is understood that the images may be thermal scans that show areas of different temperatures. In other cases, the controller 2 interprets the thermal images to display outlines of food items based on regions that have a significantly lower temperature than the grill surface or the plane of the grill surface. In order to identify food items, the controller in connection with the thermal imaging camera may determine the location where there is a sharp temperature increase and then an outline of the sharp temperature increase may show the perimeter of the food item.

These perimeters may be displayed on display 3000. For example, the perimeter of the steak 16′ may be displayed. The display 3000 may be touch sensitive such that the user can press inside the perimeter to select the type of meat, doneness and/or temperature. For example, the user may press image 16′ (or within the perimeter thereof) and the user may then be prompted to select if they would like to designate a cooking temperature. In some cases, there may be option to select the type of meet and doneness. For example, the user could select steak-medium. Based on cooking guidelines (USDA or other), the system may then know that the internal temperature should be 135 for beef to be cooked to medium. In some cases, the final desired temperature may be 140 and a rest or carryover time of a few minutes may be used to calculate the final temperature. For example, taking a steak off at 135 and covering it with foil for 5-10 minutes may allow the internal temperature to rise to 140 or more. The change in temperature after the food is removed has to do with the residual heat closer to the grill surface that passes through to the center of the meat when the meat is allowed to rest after removal.

FIG. 1 also shows that different types of meat can be used. Therefore, the user can select each piece of meat one-by one and associate a temperature or doneness with the particular piece. For example, pork may reach medium at a temperature of 150. The controller 2 in connection with the camera 4 may read the different temperatures of the different food items.

It is also understood that the system can allow the user to select an area containing multiple food items. For example, the left side of the grill may have hamburgers and the right side may have fish. The system can then determine where each individual food item is on the grill based on the thermal image and the perimeter determined based on the temperature differences. Each individual food item within the selected area can then be associated with a particular cooking temperature.

As a further example, if the user desires to cook multiple hamburgers to different temperatures, the system could allow the user to select how many are medium, how many are medium-rare and how many are well done. Since the grill may have hot spots, the system can then be configured to select which of the hamburgers will be cooked to the different temperatures so that the cooking time for all burgers is closer. For example, the hamburger located in a hotter part of the grill would be selected by the controller as well done where one located on a cooler part of the grill would be selected as medium-rare.

The controller 2 and the camera 4 may also be configured to determine the thickness of a particular food item, the temperature within the grill (between the grill 22 and the cover) and the temperature of the grill 22 (or grill surface). Based on the type of food item selected, different thermal conductivity coefficients can be assigned to the different food items. Using these variables, the cooking time of each food item can be determined.

The display 3000 may be affixed to the controller 2 or may be a separate display. The controller/display may be in wireless communication with a mobile device 10. In some cases, the display is removed and the controller 2 is directly in communication with the mobile device 10 and the display functions, selections and inputs are made via the mobile device. It is also contemplated that hard wired connections may be used between the controller and/or the display and the mobile device.

The software of the controller can also calculate when particular food items should be flipped, depending on what the food item is. As one example, a thick piece of steak is usually seared on both sides over high heat and then placed in an area of indirect or lower heat until the appropriate internal temperature is reached. The system may be configured to regulate the heat source 20 based on the location of the food items and the preferred cooking methods and techniques.

Each food item may have different flip times based on calculations that would be expected to be relatively close. Therefore, the system can be configured to determine a grouping of multiple food items that should be flipped at once. These can be highlighted or indicated on the display and alerts can be issued telling the user to flip particular food items in groups.

After flipping or moving of the food items, the camera and controller can be used to determine where the food items have moved to based on previously read internal temperatures and shapes and sizes of the food items. The display can also show graphics that indicate the settings applied to the food items once flipped so the user can re-confirm settings. As one example, the controller may know to re-determine location of food items each time the grill lid is opened. The grill lid opening would significantly change the profile read by the camera/controller, which is how the camera/controller would know the lid was opened. A sensor or switch may also be configured to read the position of the grill lid.

Once the desired cooking temperature is reached when taking into account carryover time as necessary, alerts can be issued to the user so that they know to remove the food from the grill. The alerts may also be issued a few minutes in advance of the food being done so that the user can get to the grill in time. The warnings and notifications can be calculated automatically or may be set by the user.

Although some calculations are discussed as being performed by the controller, it is contemplated that the controller can be configured to send data to the mobile device and a software application executing on the mobile device could be configured to perform the calculations, issue alerts and perform other functions contemplated herein.

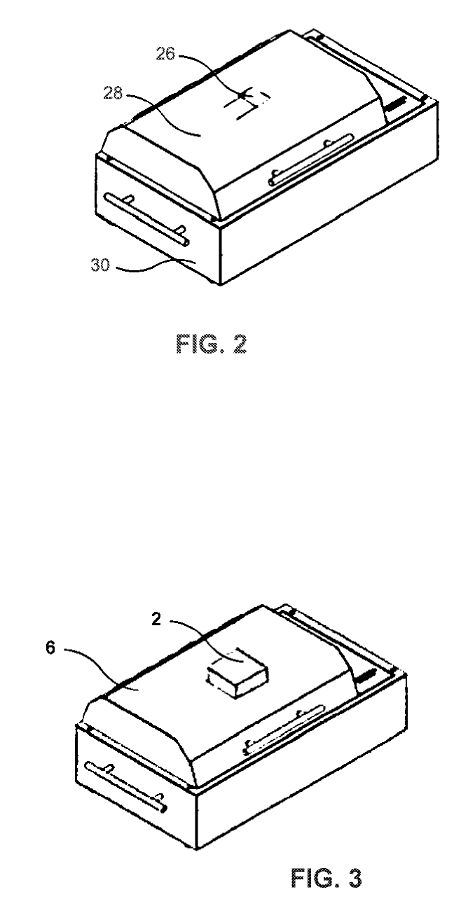

FIGS. 2 and 3 show the grill enclosure with hole 26 in the lid 28. Heat source may be located in the bottom section 30 of the grill. As shown in FIG. 3, controller 2 is affixed to the lid 28 at the hole 26 so that the camera 4 can read measure temperatures as discussed herein. Hole 26 may be associated with a sliding or removable cover that can be used to cover the hole 26 when the controller 2 is removed.

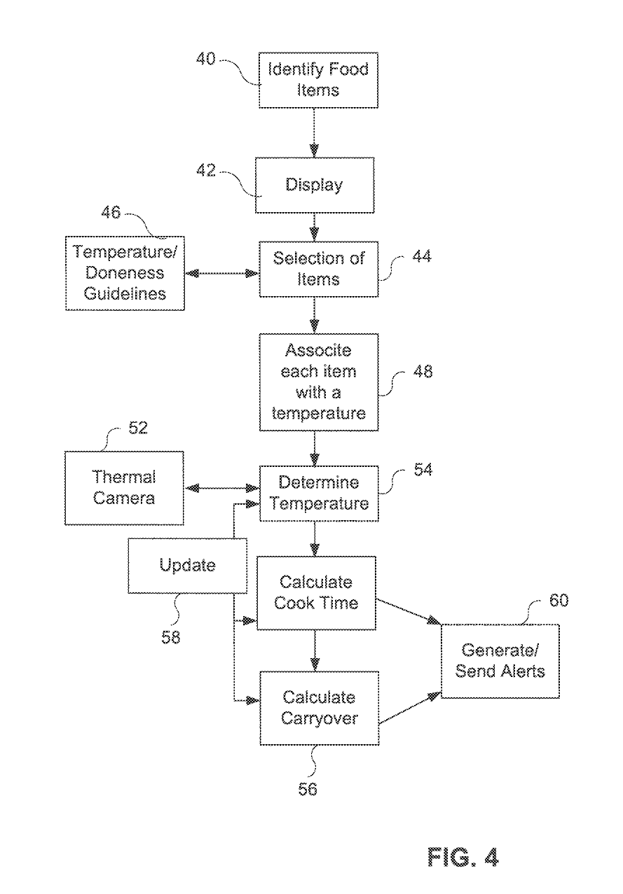

In FIG. 4, an exemplary process executed by the software is shown. The food items are identified 40 using the camera 4, and this may be based on the sharp temperature changes between the food and the grill. The images or perimeters of the food items may be displayed 42. A selection of the items 44 may be received. The selection may be based on temperature or doneness guidelines 46 (USDA or other). As previously discussed, multiple items may be selected of different types (fish, beef, pork etc). It is also contemplated that an area can be selected as well. Each item is then associated with a temperature 48. The temperature of the food item is then determined 50 using to thermal camera 52 (the thermal camera may be camera 4 or part thereof). The cooking time 54 and the carryover 56 may be updated continuously as the temperature increases during cooking. The cooking time may be calculated as discussed previously based on the thickness and thermal conductivity of the meat. It is also contemplated that the system can track the temperature change of the meat over a period of time and then update the thermal conductivity for each piece of meat based on the known quantities of the grill temperature, temperature within the grill lid, thickness etc. This cooking time may be updated based on the rate of change of the temperature of the food item monitored. The software can then generate and send alerts 60. These alerts may intermediate to flip the food items. The alerts may also indicate that the food items are or are about to be done cooking. It is further contemplated that the heat source 20 can be regulated depending on the thickness and desired cooking time. It is further contemplated that the system can turn the heat source off when cooking is finished.

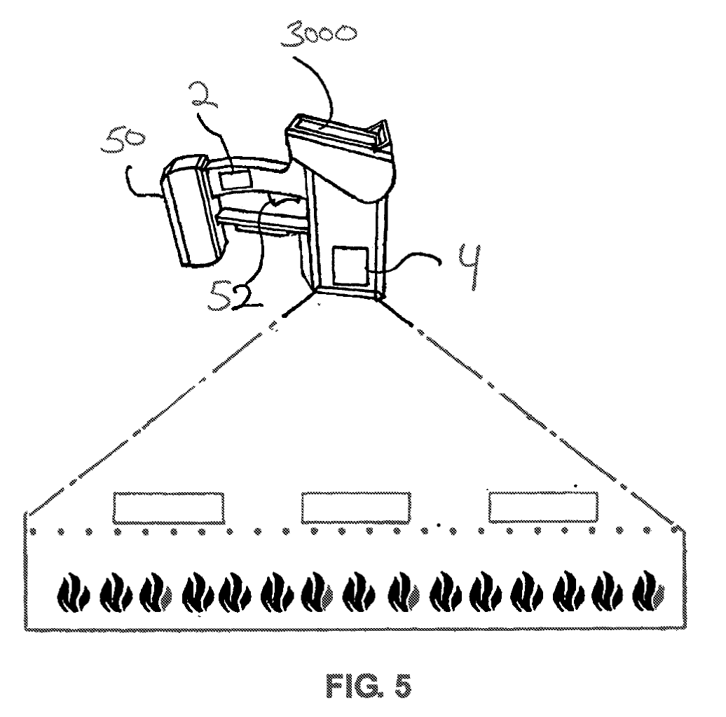

In one embodiment shown in FIG. 5, the controller 2, camera 4 and display 3000 are coupled to a housing 50 such that the unit is configured as a handheld device. In this embodiment, the camera is pointed towards the grill as shown in FIG. 5 and the thickness, temperature and other parameters of the items on the grill can be determined to calculate cooking times.

The grill in FIG. 5 is shown with the cover open (or removed). In the grill mounted embodiment of FIG. 1, the camera is in a fixed position relative to the grill, thus once the food items and type are identified by the user, the position of the field of view of the camera relative to the grill does not change.

In the hand held embodiment of FIG. 5, the user may not always position the camera in the same location when pointing at the grill/food items. Therefore, reference points may be identified by the controller 2 based on data from the camera 4. For example, the position the camera field of view can be determined partially based on the grill surface, which normally will have multiple parallel metal bars which will be relatively hot compared to the food and thus can be identified based on their infared spectral image as such. Thus, when the user points the handheld device at the grill, these reference locations are determined and stored by the controller, for example, in a memory of the controller or a memory within the housing 50. The user can press trigger 52 to take picture with camera 2. Then, the user can identify the food items on the display 3000 and select the food type and cooking temperature desired. The software that executes on the controller would then determine where the grill bars are (or the pattern of the grill surface) and use this as a reference point. If the user next checks the food and were to do so with the handheld device 90 degrees relative to what is shown in FIG. 5, the controller would be able to determine the direction/pattern of the grill bars/surface and use this as a reference point. In addition, the back of the grill is normally closed whereas, the front would be open (when the lid is open to take a picture) and the edges of the grill surface can further be identified by the camera or selected by the user when setting up the handheld device. These additional reference locations/patterns can be used to determine what the camera is pointing at so that the user does not need to re-select the food items after each time the user checks the food items with the handheld device.

The handheld device can also identify the outline/shape of the food items so that when flipped or moved on the grill surface, the user does not need to re-select the food items via the display 3000. The previously read internal temperatures can also be used to aid in identifying food items. The display could also alert the user that it has determined that food items were moved/flipped and show on the display 3000 what items are identified with particular cooking temperatures and type of food.

The process of FIG. 4 for identifying and monitoring the cooking of the food items can be equally applied to the handheld embodiment.

It is understood that the handheld embodiment can also utilize the features described as to the grill lid mounted embodiment of FIG. 1 as well as any other features described herein.

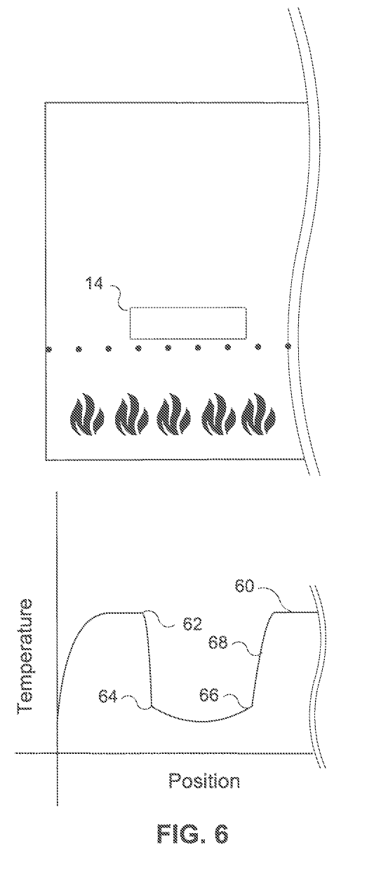

Referring to FIG. 6 a section view of the grill and its corresponding measured temperature profile is shown. The areas adjacent to the food item 62/60 would generally be measured as the temperature of the grilling surface or of the grill enclosure. This may be around 400-600 degrees in one example. The temperature would drop rapidly between area 60 and edge 66 along boundary 68 and then the measured temperature would correspond to that of the food item. The edge of the food item 64/66 could therefore be determined based on where the camera measures the drop in temperature and then a temperature profile that is generally flatter as shown between edge 64 and 66. It is understood that this would be a cross sectional profile of the temperature profile and that as the food item became narrower, edges 64 and 66 would move together and that where the food item ends (going in/out of the page), the profile would look generally flat with line 62 extending into line 60. Thus, as moving in/out of the page with the temperature profile shown in FIG. 6 the points 62/64 would be tracked along the z axis (coming out of the page) so that a closed loop pattern could be determined based on multiple cross section temperature profiles. Since the camera is looking down on the food item/grill, it is possible to identify the outline of the food item based on these temperature drops. As has also been described previously, grill hot spots can be identified based on the temperature profiles. Given that the food items normally cook to 130-180 degrees, the colder spots would be known to correspond to the food items whereas the hot spots would correspond to much higher temperatures such that the boundary thereof would be identified in the reverse way, i.e. the temperature increasing inwards towards the hot spot whereas the colder spots that would associate with the food item would decrease in temperature inwardly. The boundary would be determined by locating the areas of rapid changes in temperature associated with a drop in measured temperature of 1.5-2.5 times the grill temperature 62 over a relatively narrow width. For example, less than 1 inch or more preferably less than 0.5 inches or even more preferably 0.25 inches which is measured between 62 and 64. Once identified, the boundary would generally in a fixed location unless the grill lid is opened. Once opened, the boundaries would be re-determined and the perimeter shape thereof identified to determine which food items had been moved where based on matching shapes (which may have been flipped).

It should be appreciated that although a particular grill embodiment is described herein, it is understood that the features described above with respect to a grill are not limiting as to the cooking method or apparatus. Particularly, the features described can be used in a variety of cooking environments such as an oven, pot, a stove top, frying pan, griddle, or other cooking environments whether electric, fuel or other energy sources are used.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A grill temperature sensor comprising:
a controller including a camera coupled thereto, the camera identifying thermal properties of at least one food item on a grill;
a display in communication with the controller, the controller transmitting data representative the thermal properties of the at least one food item for display;
a selection received in connection with the data and associating a temperature with the at least one food item;
the controller monitoring a thermal value of the at least one food item and generating an alert indicative of when the temperature is reached for the at least one food item.

2. The device of claim 1 wherein the data is an image.

3. The device of claim 1 wherein the selection is an area containing at least two food items.

4. The device of claim 1 wherein the selection is indicative of food type and doneness.

5. The device of claim 4 wherein the doneness is based on a scale between rare and well done.

6. The device of claim 1 further comprising:
a housing having the controller, camera and display coupled thereto such that the grill temperature sensor is a hand holdable device.

7. The device of claim 6 further comprising a trigger positioned on said housing such that activation of said trigger causes a thermal image to be taken by the camera for processing by the controller.

8. The device of claim 1 wherein the alert indicative of when the at least one food item is suggested to be flipped.

9. The device of claim 1 wherein the controller is configured to communicate wirelessly with a mobile device having said display thereon.

10. A cooking temperature sensor comprising:
a controller;
a camera in communication with said controller, the camera identifying thermal properties of at least one food item in a cooking environment based at least in part on infrared energy emitted by the at least one food item as measured by the camera;
said controller configured to receive signals from the camera, the signals indicative of the thermal properties;
a selection received by the controller to associate a temperature with the at least one food item; and
software executing on the controller which determines a thermal value of the at least one food item based on the thermal properties identified by the camera, said software generating an alert indicative of when the temperature is reached for the at least one food item.

11. The device of claim 10 wherein the selection is indicative of food type and doneness.

12. The device of claim 10 wherein the thermal value is determined at least based on an emissivity of the at least one food item.

13. The device of claim 12 wherein the selection indicates a food type having an emissivity associated therewith.

14. The device of claim 10 wherein said software identifies the at least one food item by determining a boundary associated therewith, the boundary being determined based on identifying a first temperature associated with a grilling surface and comparing the first temperature to the thermal value wherein the boundary is defined around a perimeter of the at least one food item where the first temperature is at least 1.5 times the thermal value.

15. The device of claim 10 wherein based on the selection, the temperature is determined at least in part based on a thickness of the at least one food item.

16. The device of claim 11 wherein the selection is indicative of a final temperature and the temperature is calculated based on an estimated carry-over temperature change such that the alert is generated when the temperature is lower than the final temperature.

17. A method of measuring a temperature of one or more food items in a cooking environment comprising the steps of:
capturing with an imaging device an infrared energy associated with an area of the cooking environment;
identifying the one or more food items based on a drop in the infrared energy being measured in a closed loop pattern within the area;
associating a temperature with at least one of the identified one or more food items; and
generating an alert when the temperature is reached.

18. The method of claim 17 wherein the drop is at least 1.5 times a measured temperature adjacent to the closed loop pattern over a distance of one inch or less.

19. The method of claim 17 wherein the drop is at least 1.5 times a measured temperature adjacent to the closed loop pattern over a distance of half an inch or less.

20. The method of claim 17 wherein the drop is at least 1.5 times a measured temperature adjacent to the closed loop pattern over a distance of a quarter inch or less.
